(19) United States
(12) Patent Application Publication
(10) Pub. No.: US 2018/0119258 A1
(43) Pub. Date: May 3, 2018

(54) NON-ORIENTED MAGNETIC STEEL SHEET

(71) Applicant: NIPPON STEEL & SUMITOMO METAL CORPORATION, Tokyo (JP)

(72) Inventors: Masahiro FUJIKURA, Tokyo (JP); Shinichi MATSUI, Kitakyushu-shi (JP); Shinichi KANAO, Kitakyushu-shi (JP); Takeo ARAMAKI, Kitakyushu-shi (JP); Yoshiyuki USHIGAMI, Kitakyushu-shi (JP)

(73) Assignee: NIPPON STEEL & SUMITOMO METAL CORPORATION, Tokyo (JP)

(21) Appl. No.: 15/568,665

(22) PCT Filed: Apr. 21, 2016
(86) PCT No.: PCT/JP2016/062626

§ 371 Date: Oct. 23, 2017

(30) Foreign Application Priority Data
Apr. 27, 2015 (JP) 2015-090617

(51) Int. Cl. C22C 38/60; C22C 38/16; C22C 38/14; C22C 38/12; C22C 38/08; C22C 38/06; C22C 38/04; C22C 38/02; C22C 38/00; C21D 8/12; C21D 9/46; H01F 1/147

(52) U.S. Cl. CPC C22C 38/60; C21D 2211/005; C22C 38/14; C22C 38/12; C22C 38/08; C22C 38/06; C22C 38/04; C22C 38/02; C22C 38/008; C22C 38/005; C22C 38/002; C22C 38/001; C21D 8/1272; C21D 9/46; H01F 1/14791; C22C 38/16

(57) ABSTRACT

There is provided a non-oriented magnetic steel sheet according to one aspect of the present invention including a predetermined composition, wherein a structure contains 99.0% by area or more of ferrite grains which do not have an unrecrystallized structure, wherein an average crystal grain size of the ferrite grains is 30 μm to 180 μm, wherein the ferrite grains contain metal Cu particles of which a number density is 10,000 to 10,000,000 number/μm³ on the inside thereof, wherein the metal Cu particles on the inside of the ferrite grains contain precipitation particles having a 9R structure of which a number density is 2% to 100% with respect to the number density of the metal Cu particles, and precipitation particles having a bee structure of which a number density is 0% to 98% with respect to the number density of the metal Cu particles, and wherein an average grain size of the metal Cu particles on the inside of the ferrite grains is 2.0 nm to 10.0 nm.

### TECHNICAL FIELD OF THE INVENTION

The present invention relates to a non-oriented magnetic steel sheet which is used as a core material of a driving motor of an electric vehicle or the like or a motor for various electric equipment.

Priority is claimed on Japanese Patent Application No. 2015-090617, filed on Apr. 27, 2015, the content of which is incorporated herein by reference.

### Related Art

In recent years, for the use in a vehicle or the like, a motor which has a large capacity and rotates at a high speed has been widely used. In a material for a rotor of the motor, not only excellent magnetic properties but also a mechanical strength for enduring a centrifugal force or stress variation has been required. In particular, in order to respond to the stress variation, a high fatigue strength is necessary, but in general, the fatigue strength is improved as a tensile strength TS increases.

For example, as can be seen in Patent Documents 1 to 4, as a method of achieving both of the low iron loss and the high strength, a method of increasing the strength of a steel sheet by finely precipitating metal Cu particles after cold rolling and recrystallization is suggested. By precipitating fine Cu not to influence coarsening of recrystallization and movement of a magnetic wall, it is possible to achieve both of the low iron loss and the high strength.

### PRIOR ART DOCUMENT

### Patent Document

[Patent Document 1] Japanese Unexamined Patent Application, First Publication No. 2004-084053

[Patent Document 2] PCT International Publication No. WO 2005/033349

[Patent Document 3] Japanese Unexamined Patent Application, First Publication No. 2004-183066

[Patent Document 4] PCT International Publication No. WO 2004/50934

### Non Patent Document

[Non Patent Document 1] P. J. Othen et al. Philosophical Magazine Letters, 64(1991)383

### DISCLOSURE OF THE INVENTION

### Problems to be Solved by the Invention

Considering improvement of fatigue properties of a non-oriented magnetic steel sheet having low iron loss in which metal Cu particles are precipitated as a problem, an object of the present invention is to provide a non-oriented magnetic steel sheet having low iron loss that solves the problem and a method of manufacturing the same.

### Means for Solving the Problem

The inventors have thoroughly investigated a method of solving the above-described problem. As a result, it was found that it is possible to realize a high tensile strength and a high fatigue strength while maintaining excellent magnetic properties when a hot rolling condition and a precipitating condition of Cu are appropriately combined.

The present invention is based on the above-described knowledge, and the main idea of the present invention is as follows.

(1) According to an aspect of the present invention, there is provided a non-oriented magnetic steel sheet includes, as a composition, by mass %: C: 0% to 0.0100%; Si: 1.00% to 4.00%; Mn: 0.05% to 1.00%; Al: 0.10% to 3.00%; Cu: 0.50% to 2.00%; Ni: 0% to 3.00%; Ca: 0% to 0.0100%; REM: 0% to 0.0100%; Sn: 0% to 0.3%; Sb: 0% to 0.3%; S: 0% to 0.01%; P: 0% to 0.01%; N: 0% to 0.01%; O: 0% to 0.01%; Ti: 0% to 0.01%; Nb: 0% to 0.01%; V: 0% to 0.01%; Zr: 0% to 0.01%; Mg: 0% to 0.01%; and a remainder of Fe and impurities, wherein a structure contains 99.0% by area or more of ferrite grains which do not have an unrecrystallized structure, wherein an average crystal grain size of the ferrite grains is 30 μm to 180 μm, wherein the ferrite grains contain metal Cu particles of which a number density is 10,000 to 10,000,000 number/μm³ on the inside thereof, wherein the metal Cu particles on the inside of the ferrite grains contain precipitation particles having a 9R structure of which a number density is 2% to 100% with respect to the number density of the metal Cu particles, and precipitation particles having a bee structure of which a number density is 0% to 98% with respect to the number density of the metal Cu particles, and wherein an average grain size of the metal Cu particles on the inside of the ferrite grains is 2.0 nm to 10.0 nm.

(2) The non-oriented magnetic steel sheet according to (1), may include, as a composition, by mass %: one or more selected from a group made of Ni: 0.50% to 3.00%; Ca: 0.0005% to 0.0100%; and REM: 0.0005% to 0.0100%.

### EFFECTS OF THE INVENTION

According to the present invention, it is possible to manufacture and provide a non-oriented magnetic steel sheet having low iron loss and excellent fatigue properties. The present invention can contribute to achieving a high speed and high efficiency of a motor.

### BRIEF DESCRIPTION OF THE DRAWINGS

FIG. 1-1 is a view illustrating an aspect of a test piece for a fatigue test.

FIG. 1-2 is a view illustrating an aspect of the test piece for the fatigue test.

FIG. 2 is a view illustrating a relationship between a temperature of Cu precipitation treatment and a tensile strength TS.

FIG. 3 is a view illustrating a relationship between a temperature of Cu precipitation treatment and a fatigue strength FS.

FIG. 4 is a view illustrating a relationship between a temperature of Cu precipitation treatment and iron loss W_{10/400}.

### EMBODIMENTS OF THE INVENTION

First, an experiment to obtain the knowledge which is a base of a steel sheet and a method of manufacturing the same according to the embodiment, and the result thereof will be described.

Experiment and Result Thereof

By making a steel piece having a composition (unit: mass %) illustrated in Table 1 by melting, using conditions 1 to 3 of a finish hot rolling start temperature F0T, a finishing hot roiling end temperature FT, a winding temperature CT after hot rolling which were illustrated in Table 2, a hot rolled steel sheet having a finish thickness of 2.3 mm was manufactured. The hot rolled steel sheets were pickled without annealing, then, cold-rolled, and accordingly, a cold rolled steel sheet having a thickness of 0.35 mm was obtained. After this, by soaking the cold rolled steel sheet for 30 seconds at 1000° C., and by performing recrystallization annealing of cooling the cold rolled steel sheet at an average cooling rate of 20° C./seconds within a range of 800° C. to 400° C., a recrystallized steel sheet was obtained. Furthermore, after this, by performing Cu precipitation annealing with respect to the recrystallized steel sheet, fbr 60 seconds of soaking time at various soaking temperatures within a range of 400° C. to 700° C., a steel sheet for evaluation was obtained.

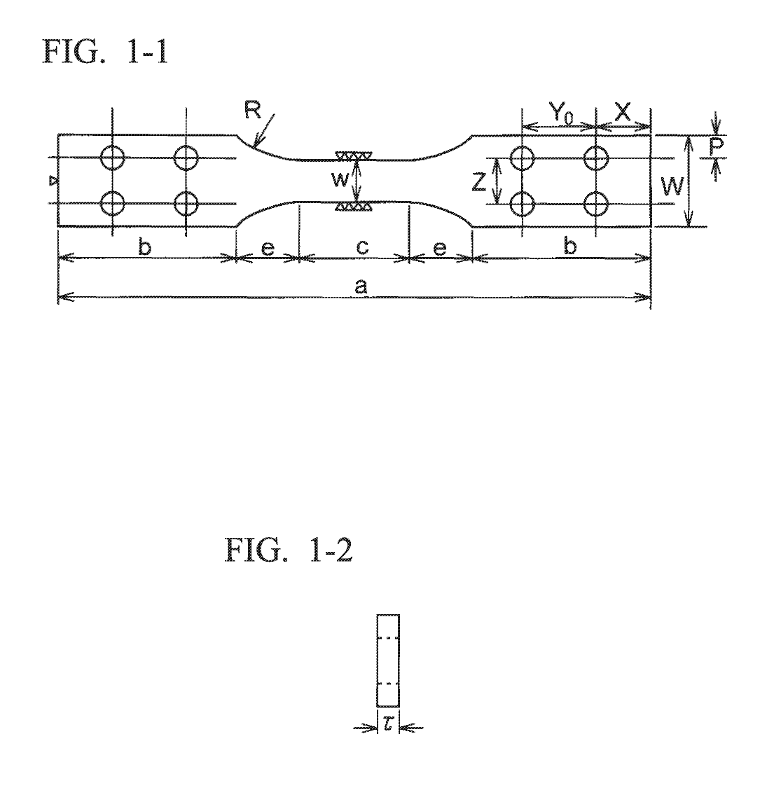

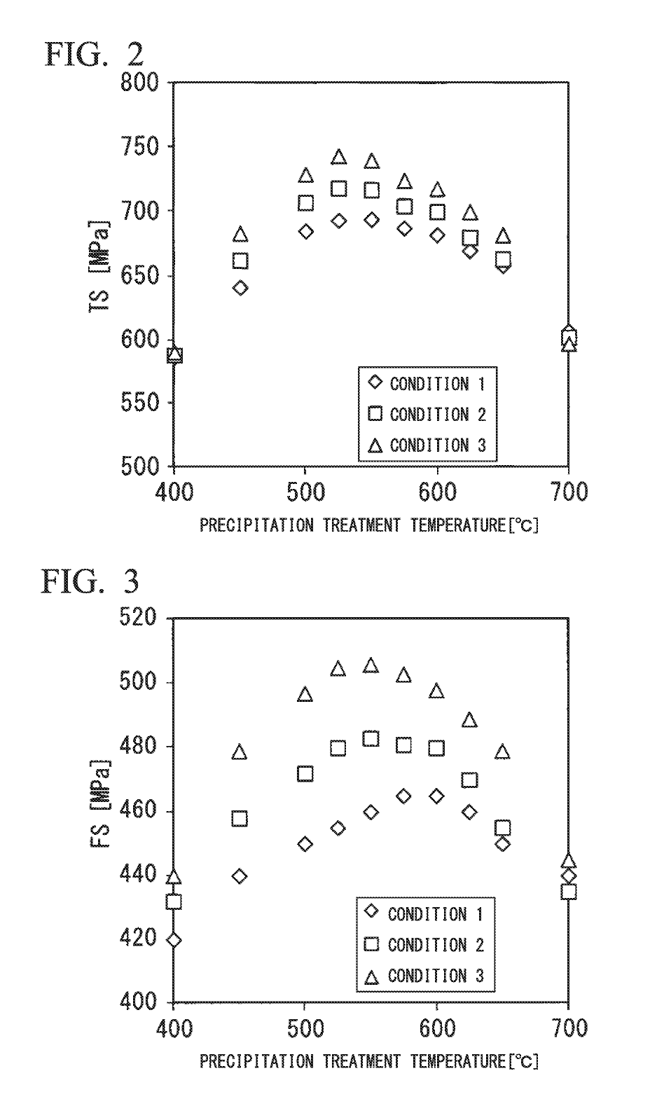

By cutting out a JIS No. 5 tension test piece from the steel sheet for evaluation, the tension test was performed based on JIS Z 2241 “Method of Tension Test of Metal Material”. A longitudinal direction of the tension test piece matches a rolling direction of the steel sheet for evaluation. Furthermore, based on JIS Z 2273 “General Rule of Method of Fatigue Test of Metal Material”, a fatigue test piece illustrated in FIGS. 1-1 and 1-2 was cut out from the steel sheet for evaluation, and a fatigue test was performed by partially pulsating tension. a, b, c, e, R, w, W, X, Y₀, Z, and τ which were illustrated in FIGS. 1-1 and 1-2, were as follows. In addition, on a surface of a necking portion of the test piece, surface finish was performed by the 600-th paper.

a: 220 mm

b: 65 mm

c: 45 mm

e: 26.5 mm

R: 35 mm

w: 25 mm

W: 50 mm

X: 16 mm

Y₀: 28 mm

Z: 26 mm

τ: 0.35 mm

The longitudinal direction of the fatigue test piece matches the rolling direction of the steel sheet for evaluation. In the fatigue test, the minimum load was set to be constant and set to be 3 kgf, the frequency was set to be 20 Hz, the maximum stress, in a case where the times of repeating stress was 2000000 and breaking did not occur, was set to he a fatigue strength FS of the steel sheet for evaluation.

In addition, a single sheet sample of 55 mm×55 mm for magnetic measurement was cut out from the steel sheet ibr evaluation, and average iron loss in the rolling direction and in the perpendicular direction was evaluated based on JIS C 2556 “Test Method of Single Sheet Magnetic Properties of Magnetic Steel Sheet”. The evaluation was performed under the condition that a frequency was 400 Hz and a magnetic flux density was 1.0T.

TABLE 1
CHEMICAL COMPOSITION (UNIT:MASS %)

| C | Si | Mn | P | S | Al | Cu |
|---|---|---|---|---|---|---|
| 0.0014 | 2.96 | 0.188 | 0.015 | 0.0013 | 0.687 | 1.158 |

TABLE 2

| | FOT | FT | CT |
|---|---|---|---|
| CONDITION 1 | 1010° C. | 920° C. | 650° C. |
| CONDITION 2 | 970° C. | 880° C. | 450° C. |
| CONDITION 3 | 910° C. | 820° C. | 400° C. |

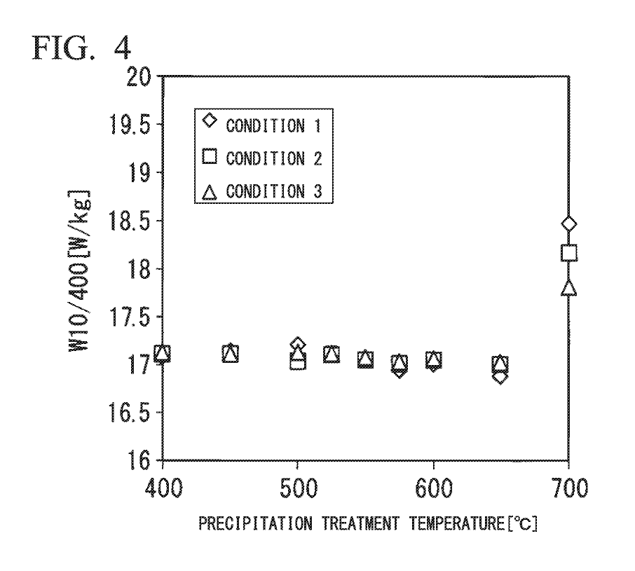

In FIG. 2, a relationship between the precipitation treatment temperature (Cu precipitation treatment temperature) in Cu precipitation annealing and a tensile strength TS, is illustrated, and in FIG. 3, a relationship between the precipitation treatment temperature and the fatigue strength FS is illustrated. From FIGS. 2 and 3, in a hot rolling condition 1 illustrated in Table 1, it is ascertained that the Cu precipitation treatment temperature at which TS (tensile strength) becomes the highest is 525° C. to 550° C., and the Cu precipitation treatment temperature at which FS (fatigue strength) becomes the highest is 575° C. to 600° C.

In addition, as shown in FIGS. 2 and 3, when a finish hot rolling start temperature, a finishing hot rolling end temperature, and a winding temperature decrease, TS and FS increase, and the Cu precipitation treatment temperature at which the TS becomes the highest does not change that much. However, the Cu precipitation treatment temperature at which the FS becomes the highest decreases.

In other words, from FIGS. 2 and 3, it is ascertained that it is possible to realize both of the high tensile strength and the high fatigue strength by appropriately combining the hot rolling condition and the Cu precipitation condition.

Here, in FIG. 4, a relationship between the Cu precipitation treatment temperature and iron loss W_{10/400} is illustrated. From FIG. 4, it is ascertained that, in any hot rolling condition, in a case where the Cu precipitation treatment temperature is 700° C., iron loss slightly increases, and in a case where the Cu precipitation treatment temperature is equal to or lower than 650° C., influence of the Cu precipitation treatment temperature on the iron loss is small.

The inventors have investigated that precipitation morphology of Cu in a ferrite crystal grain of a test material using a transmission electron microscope (TEM), in order to more specifically investigate a relationship between the heat treatment condition and the tensile strength, and a relationship between the fatigue strength and the iron loss, which are determined from the above-described experiment result. Under the hot rolling condition 1 where the Cu precipitation treatment temperature was 550° C., an average precipitation grain size of Cu was 2.3 nm and a crystal structure of all of the observed Cu particles was BCC. Under the hot rolling condition 3 where the Cu precipitation treatment temperature was 650° C., the average precipitation grain size of Cu was 7 nm, and both of the BCC structure and a 9R structure or a FCC structure were observed as the crystal structure of the Cu particles.

Based on. the observation, in Table 3, the average grain size of the precipitated Cu particles, the number density per volume, a proportion of the number density of 9R particles with respect to the number density of all of the precipitated Cu particles, and a proportion of the number density of the BCC particles, in a case of changing the hot rolling condition and the Cu precipitation treatment temperature, were illustrated. It was ascertained that, when comparing the fatigue strength of FIG. 3 and the precipitated state of Cu of Table 3 with each other, under the condition that the fatigue strength was high in each of the hot rolling conditions, both of the Cu particles of the BCC structure and the particles of the 9R structure were included. Furthermore, under the hot rolling conditions 2 and 3 where TS and FS were high, it was ascertained that the number density of the Cu particles was high compared to that of the hot rolling condition I even under the same Cu precipitation annealing condition.

TABLE 3

| | CONDITION 1 | | | | |
|---|---|---|---|---|---|
| | PRECIPITATED Cu PARTICLES | | | | |
| PRECIPITATION | | | | NUMBER | NUMBER |
| ANNEALING | AVERAGE | NUMBER | CRYSTAL | PROPORTION | PROPORTION |
| TEMPERATURE | GRAIN SIZE | DENSITY | STRUCTURE OF | OF 9R | OF BCC |
| [° C.] | [nm] | [1/μm³] | PARTICLES | PARTICLE | PARTICLE |
| 400 | COULD NOT | = | COULD NOT | = | = |
| | BE OBSERVED | | BE OBSERVED | | |
| 450 | COULD NOT | = | COULD NOT | = | = |
| | BE OBSERVED | | BE OBSERVED | | |
| 500 | 2.3 | 586000 | BCC | 0% | 100% |
| 525 | 2.2 | 639000 | BCC | 0% | 100% |
| 550 | 2.5 | 251000 | BCC | 0% | 100% |
| 575 | 3.3 | 109000 | BCC + 9R | 15% | 85% |
| 600 | 7 | 11400 | BCC + 9R + FCC | 55% | 36% |
| 625 | 12 | 2270 | BCC + 9R + FCC | 17% | 2% |
| 650 | 19 | 573 | FCC | 0% | 0% |
| 700 | 28 | 179 | FCC | 0% | 0% |
| | CONDITION 2 | | | | |
| | PRECIPITATED Cu PARTICLES | | | | |
| PRECIPITATION | | | | NUMBER | NUMBER |
| ANNEALING | AVERAGE | NUMBER | CRYSTAL | OF 9R | OF BCC |
| TEMPERATURE | GRAIN SIZE | DENSITY | STRUCTURE OF | PROPORTION | PROPORTION |
| [° C.] | [nm] | [1/μm³] | PARTICLES | PARTICLE | PARTICLE |
| 400 | COULD NOT | = | COULD NOT | = | = |
| | BE OBSERVED | | BE OBSERVED | | |
| 450 | 2.3 | 1620000 | BCC | 0% | 100% |
| 500 | 2.2 | 1840000 | BCC | 0% | 100% |
| 525 | 2.5 | 1260000 | BCC + 9R | 5% | 95% |
| 550 | 3.6 | 421000 | BCC + 9R | 16% | 84% |
| 575 | 4.2 | 265229 | BCC + 9R | 35% | 65% |
| 600 | 7.1 | 54900 | BCC + 9R + FCC | 56% | 25% |
| 625 | 9 | 26700 | BCC + 9R + FCC | 29% | 8% |
| 650 | 13 | 8940 | BCC + 9R + FCC | 15% | 3% |
| 700 | 21 | 2120 | FCC | 0% | 0% |
| | CONDITION 3 | | | | |
| | PRECIPITATED Cu PARTICLES | | | | |
| PRECIPITATION | | | | NUMBER | NUMBER |
| ANNEALING | AVERAGE | NUMBER | CRYSTAL | OF 9R | OF BCC |
| TEMPERATURE | GRAIN SIZE | DENSITY | STRUCTURE OF | PROPORTION | PROPORTION |
| [° C.] | [nm] | [1/μm³] | PARTICLES | PARTICLE | PARTICLE |
| 400 | COULD NOT | = | COULD NOT | = | = |
| | BE OBSERVED | | BE OBSERVED | | |
| 450 | 2.3 | 3210000 | BCC | 0% | 100% |
| 500 | 3.1 | 2640000 | BCC + 9R | 11% | 89% |
| 525 | 3.2 | 3000000 | BCC + 9R | 15% | 85% |
| 550 | 3.3 | 1090000 | BCC + 9R | 18% | 82% |
| 575 | 3.6 | 842000 | BCC + 9R | 30% | 70% |
| 600 | 3.8 | 716000 | BCC + 9R | 52% | 48% |
| 625 | 6 | 182000 | BCC + 9R + FCC | 68% | 32% |
| 650 | 7 | 115000 | BCC + 9R + FCC | 55% | 17% |
| 700 | 15 | 11600 | BCC + 9R + FCC | 8% | 5% |

It is known that the Cu particles in α-Fe change the crystal structure in accordance with an increase in precipitation size, and change coherence with Fe which is a matrix. In other words, in a precipitation initial stage, Cu is precipitated in the BCC structure which is coherent to the matrix, and an energy increase of an interface is suppressed. In a case of slight growth, the crystal structure which is called the 9R structure that is close to the FCC structure which is originally stable, and the matrix becomes in a semicoherent state. Furthermore, when the temperature increases, the structure changes to the FCC structure which is a stabilized phase and the matrix becomes completely non-coherent. Here, the 9R structure is a long-period structure in which a layering period of a close-packed surface of atoms is 9 layers as illustrated in FIG. 4 of Non Patent Document 1.

The fatigue strength increases in a case of containing the Cu particles of the 9R structure. This is assumed that this is because cutting of the Cu particles occur by a repeating stress in a case of the Cu particles of the BCC structure that is coherent to the matrix, but cutting is unlikely to occur in a case of the Cu particles of the semicoherent 9R structure. Furthermore, since the Cu particles of the BCC structure do not suppress the movement of dislocation, the Cu particles do not influence the mechanical strength of the steel sheet. However, since the Cu particles of the 9R structure suppress the movement of dislocation, it is assumed that the Cu particles of the 9R structure have a function of improving the mechanical strength (for example, tensile strength) of the steel sheet.

When the particle size increases for obtaining the 9R structure, the number density inevitably decreases, and the mechanical strength decreases. However, it is ascertained that, when viewing Tables 3-1 to 3-3 illustrated in advance, by decreasing F0T, FT, and CT when the hot rolling is performed, even when the Cu particle size increases to a certain degree, it is possible to maintain the number density of the Cu particles to be large. In other words, by decreasing F0T, FT, and CT when the hot rolling is performed, while containing the particles of the 9R structure in the steel sheet, it is possible to increase the number density of the particles.

From the above-described result, the inventors have found that it is important to contain the Cu particles of the 9R structure in the Cu particles in order to improve the fatigue strength, and it is important to perform the hot rolling under the optimal condition in order to increase the number density.

Hereinafter, the steel sheet according to the embodiment will be described.

Composition

First, the reason why the composition of the steel sheet according to the embodiment is limited will be described. Hereinafter, % related to the composition means mass %.

C: 0% to 0.0100%

C is an element which increases the iron loss of the magnetic steel sheet, further causes magnetic aging, and thus, is harmful to the magnetic steel sheet. In a case where the amount of C exceeds 0.0100%, the iron loss increases, the magnetic aging becomes substantial, and thus, the amount of C is set to be 0.0100% or less. The amount of C is preferably 0.0050% or less or 0.0030% or less. Since C is not necessary in the steel sheet according to the embodiment, a lower limit value of the amount of C is 0%. However, there is a case where significant costs are required in order to remove C. Therefore, the amount of C may exceed 0%, may be 0.0001% or more, may be 0.0005% or more, or may be 0.0010% or more.

Si: 1.00% to 4.00%

Si is an element which contributes to reducing of the iron loss of the magnetic steel sheet by increasing specific resistance of the steel. In a case where the amount of Si is less than 1.00%, an effect of reducing the iron loss is not sufficiently achieved, and thus, the amount of Si is 1.00% or more. The amount of Si is preferably 2.00% or more, 2.20% or more, or 2.50% or more.

Meanwhile, in a case where the amount of Si exceeds 4.00%, the steel is embrittled, and troubles, such as defects and cracks, are likely to be generated during the rolling. Therefore, the amount of Si is 4.00% or less. The amount of Si is preferably 3.60% or less, 3.50% or less, or 3.40% or less.

Mn: 0.05% to 1.00%

Mn is an element which increases the specific resistance of steel, and performs an action of coarsening and detoxifying the sulfide. In a case where the amount of Mn is less than 0.05%, the above-described effect is not sufficiently achieved, and thus, the amount of Mn is set to be 0.05% or more. The amount of Mn is preferably 0.10% or more, 0.15% or more, or 0.20% or more.

Meanwhile, in a case where the amount of Mn exceeds 1.00%, the steel is embrittled, and troubles, such as defects and cracks, are likely to be generated during the rolling. Therefore, the amount of Mn is set to be 1.00% or less. The amount of Mn is preferably 0.90% or less, 0.80% or less, or 0.70% or less.

Al: 0.10% to 3.00%

Al is an element which has an deoxidation effect, and performs an action of preventing fine precipitation of the nitride by precipitating as a large-sized AlN. In addition, Al is an element which contributes to increasing the specific resistance of the steel and reducing the iron loss, similar to Si and Mn.

In a case where the amount of Al is less than 0.10%, the above-described effect is not sufficiently achieved, and thus, the amount of Al is set to be 0.10% or more. The amount of Al is preferably 0.15% or more, 0.20% or more, or 0.30° /h or more. Meanwhile, in a case where the amount of Al exceeds 3.00%, the steel is embrittled and troubles, such as defects and cracks, are likely to be generated during the rolling, and thus, the amount of Al is set to be 3.00% or less. The amount of Al is preferably 2.00% or less, 1.50% or less, or 1.20% or less.

Cu: 0.50% to 2.00%

Cu is an important element in the steel sheet according to the embodiment. By finely precipitating the metal Cu in the steel sheet, without increasing the iron loss of the steel sheet, the yield strength (YS), the tensile strength (TS), and the fatigue strength (FS) of the steel sheet are improved. Ln. a case where the amount of Cu is less than 0.50%, the above-described effect is not sufficiently achieved, and thus, the amount of Cu is set to be 0.50% or more. The amount of Cu is preferably 0.80% or more, 0.90% or more, or 1.00% or more.

Meanwhile, in a case where the amount of Cu exceeds 2.00%, during the hot rolling the steel sheet, defects and cracks are likely to be caused in the steel sheet, and thus, the amount of Cu is set to be 2.00% or less. The amount of Cu is preferably 1.80% or less, 1.60% or less, or 1.40% or less.

The steel sheet according to the embodiment may contain one or more selected from the group made of Ni, Ca, and REM, in addition to the above-described elements. In addition, the steel sheet according to the embodiment may contain Sn and Sb, in addition to the above-described elements. However, even in a case where Ni, Ca, REM, Sn, and Sb are not contained, the steel sheet according to the embodiment has excellent properties, and thus, lower limit values of each of Ni, Ca, REM, Sn, and Sb are 0%.

Ni 0% to 3.00%

Ni is may have an effect of reducing the defects of a hot rolled steel sheet, is also efficient in increasing the mechanical strength of the steel sheet by solid solution strengthening, and thus, may he contained in the steel sheet according to the embodiment. In order to obtain the above-described effect, the amount of Ni is preferably set to be 0.50% or more, and is more preferably set to be 0.80% or more, or 1.00% or more. However, since Ni is an expensive element and increases the manufacturing costs, the amount of Ni is preferably set to be 3.00% or less, and is more preferably 2.60% or less or 2.00% or less.

Ca: 0% to 0.0100%

REM: 0% to 0.0100%

Ca and REM have an effect of detoxifying S which is an element that increases the iron loss of the steel sheet by forming precipitate, by precipitating S in steel as inclusion, such as oxysulfide, at a cooling stage of casting. In order to obtain the effect, Ca and REM may he respectively contained 0.0005% or more. More preferable lower limit values of the amounts of each of Ca and REM are 0.0010% or 0.0030%. Meanwhile, in a case where the amounts of Ca and REM are excessive, the amount of inclusion containing Ca or REM increases and the iron loss decreases. Therefore, the upper limit values of the amount of each of Ca and REM are preferably 0.0100%, and are more preferably 0.009% or 0.008%. in addition, the term “REM” indicates 17 elements in total made of Sc, Y, and lanthanoid, and the above-described “amount of REM” means the total amount of the 17 elements.

Sn: 0% to 0.30%

Sb: 0% to 0.30%

Furthermore, in order to improve the magnetic properties of the steel sheet, Sn and Sb may be contained in the steel sheet. In order to obtain an effect of improving the magnetic properties, the lower limit values of the amount of each Sn and Sb are preferably 0.03%, and are more preferably 0.04% or 0.05%. However, since there is a case where Sn and Sb embrittle the steel, the upper limit values of the amount of each Sn and Sb are preferably 0.30%, and are more preferable 0.20% or 0.15%.

In addition, the steel sheet according to the embodiment may contain at least one or more selected from the group made of S, P. N, O, Ti, Nb, V. Zr, and Mg, in addition to the above-described elements. However, it is assumed that the elements do not have a function of improving the properties of the steel sheet according to the embodiment. Therefore, the lower limit values of the amounts of each of the elements are 0%. Meanwhile, since the elements increase the iron loss of the steel sheet by forming the precipitate, in a case where the elements are contained, the upper limit values of the amount of each of the elements are preferably 0.010%, and are more preferably 0.005% or 0.003%.

A remainder of the chemical composition of the steel sheet according to the embodiment consists of iron (Fe) and impurities. The impurities are original materials, such as ore or scrap, or a component mixed into the steel sheet due to various reasons in a manufacturing process, and mean materials which are allowed within a range that does not negatively influence various properties of the steel sheet according to the embodiment.

Structure of Steel Sheet and Precipitation Morphology of Cu

The steel sheet according to the embodiment is a steel sheet which has a structure made of ferrite grains that do not contain an unrecrystallized structure, contains metal Cu particles precipitated in the ferrite grains, and achieves both of the low iron loss and the high fatigue strength. The structure of the steel sheet according to the embodiment and the precipitated state of the metal Cu particles will be described hereinafter.

Ferrite Grains which do not Contain Unrecrystallized Structure: 99.0% by area or more

When the unrecrystallized structure remains in the steel sheet, the iron loss of the steel sheet substantially increases. Therefore, it is necessary that substantially all of the structures of the steel sheet according to the embodiment are ferrite and substantially all of the ferrite is recrystallized. However, containing less than approximately 1.0% by area of structures and inclusion in addition to the ferrite grains which do not contain. the recrystallized structure, are allowed. Therefore, the structure of the steel sheet according to the embodiment is regulated to a structure containing 99.0% by area or more of ferrite grains which do not contain the unrecrystallized structure.

It is possible to confirm whether or not the ferrite grains are unrecrystallized by a method of observing a general metallographic structure. In other words, after polishing the section of the steel sheet, when the polished surface is etched by an etchant, such as nital solution, the recrystallized ferrite grains are observed as bright plain crystal grains. Meanwhile, an irregular dark pattern of the unrecrystallized ferrite grain is observed on the inside.

Average Crystal Grain Size of Ferrite Grains: 30 to 180 μm

It is necessary that the average crystal grain size of the ferrite grains are set to be 30 μm or more in order to reduce hysteresis loss of the steel sheet. However, in a case where the average crystal grain size of the ferrite grains is excessively large, a high fatigue strength is not sufficiently obtained, and further, there is also a case where the iron loss deteriorates by an increase in overcurrent loss. Therefore, the average crystal grain size of the ferrite grains is 180 μm or less. A lower limit value of the average crystal grain size of the ferrite grains is preferably 30 μm, 50 μm, or 70 μm. An upper limit value of the average crystal grain size of the ferrite grains is preferably 170 μm, 160 μm, or 150 μm. In addition, the average crystal grain size of the ferrite grains can be acquired in accordance with JIS G 0551 “Microscope Test Method of Steel-Grain Size”. Since the average crystal grain size of the ferrite grains of the steel sheet according to the embodiment is constant regardless of the direction of a cut section to which grain size measurement is performed, the direction of cutting the steel sheet when measuring the average particle size of the ferrite grains is not limited.

Precipitation Morphology of Metal Cu Particles

The metal Cu particles of the steel sheet according to the embodiment mean particles substantially made of only Cu without practically forming Fe which is a base metal and an alloy or an intermetallic compound. In the ferrite grains of the steel sheet according to the embodiment, the metal Cu particles of which the average grain size is 2.0 nm to 10.0 nm and the number density measured in the ferrite grain is 10,000 to 10,000,000/μm³, are contained. Furthermore, from the above-described experiment and the result thereof, in the steel sheet according to the embodiment, 2% or more of metal Cu particles precipitated in the ferrite grains are regulated to have the 9R structure. Hereinafter, a state of the metal Cu particles of the steel sheet according to the embodiment will be described in detail.

In the steel sheet according to the embodiment, a state of the metal Cu particles in the ferrite grains is regulated, and the state of the metal particles on a ferrite grain boundary is not limited. The inventors have found that the metal Cu particles in the ferrite grains substantially influence the mechanical properties of the steel sheet according to the embodiment, but the metal Cu particles on the ferrite grain boundary are small to the extent that the influence on the mechanical properties of the steel sheet according to the embodiment can be ignored. In a case where the amount of the metal Cu particles of the ferrite grain boundary is excessively large, there is a concern that the amount of metal Cu particles in the ferrite grain is reduced, and the problem can be ignored as long as the state of the metal Cu particles in the ferrite grains is in regulated range. Therefore, in the steel sheet according to the embodiment, only the state of the metal Cu particles in the ferrite grains is regulated. Hereinafter, there is a case where the term “metal Cu particles in the ferrite grain” is shortened to “metal Cu particles”.

Average Grain Size of Metal Cu Particles in Ferrite Grains: 2.0 nm to 10.0 nm

The metal Cu particles of the steel sheet according to the embodiment are provided as means for preventing the movement of dislocation. However, a resistance force of the metal Cu particles of which the particle size is excessively small with respect to the movement of dislocation is small. Therefore, in a case where the average grain size of the metal Cu particles is excessively small, the movement of dislocation becomes easy. Meanwhile, a resistance force of the metal Cu particles having a large particle size with respect to the movement of dislocation is large, but in a case where the average particle size of the metal Cu particles is excessively large, the number density of the metal Cu particles decreases, and thus, an inter-particle distance increases, and the movement of dislocation becomes easy. In a case where the dislocation easily moves, YP, TS, and FS decrease. Furthermore, the metal. Cu particles of which the particle size is 100 nm or more to the extent of a thickness of a magnetic wall prevent movement of the magnetic wall, and increase the hysteresis loss. Therefore, in a case where the average particle size of the metal Cu particles is excessively large, the iron loss becomes defective. Meanwhile, as a result of investigation, the inventors have found that the defective iron loss due to the metal Cu precipitation particles having a grain size of 100 nm or more is within an allowable range when the average grain size of the metal Cu precipitation particles is 10.0 nm or less. Therefore, the average grain size of the metal Cu precipitation particles is set to be 2.0 nm to 10.0 nm. The average grain size of the metal Cu precipitation particles is preferably 2.2 nm or more, is more preferably 2.4 nm or more, and is still more preferably 2.5 nm or more. In addition, the average grain size of the metal Cu precipitated particles is preferably 9.0 nm or less, is more preferably 8.0 nm or less, and is still more preferably 7.0 nm or less.

In addition, the average grain size of the metal Cu particles in the ferrite grain of the steel sheet according to the embodiment is an arithmetic mean of an equivalent circle diameter of all of the metal Cu particles in the ferrite grains of which the grain size is 2.0 nm or more. In the embodiment, the average grain size of the metal Cu particles is acquired by using a bright field image of the transmission electron microscope (TEM). An area of each of the Cu particles in the image is acquired, and the diameter (equivalent circle diameter) of a circle having the area is a diameter of each of the particles. It is difficult to detect the metal Cu particles of which the particle size is less than 2.0 nm, it is considered that the metal Cu particles rarely influence the properties of the steel sheet according to the embodiment, and thus, the metal Cu particles are not considered as a measurement target.

Number Density of Metal Cu Particles in Ferrite Grains: 10,000 to 10,000,000/μm³

The number of metal Cu particles per unit volume depends on the amount of Cu, the state before the precipitation treatment, and the precipitation size. In the steel sheet according to the embodiment, in order to obtain the high fatigue strength, the number of metal Cu particles per 1 μm³ of volume in the ferrite grains is 10,000 μm³ or more. The number is preferably 100,000/μm³ or more, and is more preferably 500,000/μm³ or more. Meanwhile, in a case where the number density of the metal Cu particles is excessively large, there is a concern that the magnetic properties of the steel sheet deteriorates. Therefore, the lower limit value of the number density of the metal Cu particles in the ferrite grains is 10,000,000/μm³.

In addition, the number density of the metal Cu particles in the ferrite grains of the steel sheet according to the embodiment is the number density of all of the metal Cu particles in the ferrite grains of which the grain size is 2.0 nm or more. It is difficult to detect the metal Cu particles of which the particle size is less than 2.0 nm, it is considered that the metal Cu particles rarely influence the properties of the steel sheet according to the embodiment, and thus, the metal Cu particles are not considered as a measurement target. Number density N of the metal Cu particles in the ferrite grains of the steel sheet according to the embodiment is acquired based on the following equation, when the area of an image observed by an electron microscope is A, the number of Cu particles observed here is n, and the average grain size (arithmetic mean of equivalent circle diameter) is d.

N=n/(A×d)

Proportion of Number Density of Metal Cu Particles Having 9R Structure in Ferrite Grains of which Grain Size is 2.0 nm or More with respect to Number Density of Metal Cu Particles of which Grain Size in Ferrite Grain is 2.0 nm or More (9R Particle Ratio): 2% to 100%

Proportion of Number Density of Metal Cu Particles Having BCC Structure in Ferrite Grains of which Grain Size is 2.0 nm or More with respect to Number Density of Metal Cu Particles of which Grain Size in Ferrite Grain is 2.0 nm or More (BCC Particle Ratio): 0% to 98%

As described above, the inventors have found that the type of the crystal structure of the metal Cu particles influences the resistance force of the metal Cu particles with respect to the movement of dislocation. The resistance force of the metal Cu particles having the 9R structure (9R particles) with respect to the movement of dislocation in ferrite is high. This is because the crystal structure of ferrite around the metal Cu particles is BCC. The dislocation is unlikely to pass through the interface of particles having different crystal structures. Therefore, the interface of the 9R particles and ferrite having the BCC structure functions as resistance with respect to the movement of dislocation in ferrite. Meanwhile, the interface between the metal Cu particles (BCC particles) having the BCC structure and ferrite does not function as resistance with respect to the dislocation that moves in ferrite. Therefore, the resistance force of the BCC particles with respect to the movement of dislocation in ferrite is low.

As the number of particles which become resistance with respect to the movement of dislocation increases, the fatigue properties of the steel sheet are improved. As a result of experiment of the inventors, it was found that excellent fatigue properties are obtained when the 9R particle ratio is 2% or more. Therefore, the 9R particle ratio of the steel sheet according to the embodiment is set to be 2% or more. The 9R particle ratio is preferably 10% or more, 20% or more, or 30% or more. The 9R particle ratio may he 100%. Meanwhile, in a case where the particle ratio of BCC is 98% or more, the 9R particle ratio is excessively small, and the fatigue properties are improved. Therefore, the BCC particle ratio is set to be 98% or less. The BCC particle ratio is preferably 90% or less, 80% or less, or 70% or less. The BCC particle ratio may be 0%.

In addition, there is also a case where the crystal structure of the metal Cu particles is FCC. The inventors have confirmed and ascertained that there is a case where the 9R particles, the BCC particles, and the metal Cu particles (FCC particles) having the FCC structure are mixed in ferrite of the steel sheet according to the embodiment. However, as long as the average grain size and the number density are within the above-described range, the proportion of the number density of the FCC particles of which the particle size is 2.0 nm or more in ferrite grain with respect to the number density of all of the metal Cu particles of which the particle size is 2.0 nm or more in ferrite grain (FCC proportion) are small to the extent that can be ignored. In addition, as long as the particle ratios of the 9R particles and the BCC particle ratio are within the above-described range, the mechanical properties of the steel sheet are excellent. Therefore, the proportion of FCC of the steel sheet according to the embodiment is not particularly regulated.

As described above, since the metal Cu particles have the 9R structure and in a state of being semicoherent to a ferrite phase of the matrix, the cutting by dislocation is unlikely to occur, and the fatigue strength is improved. Furthermore, since the size of the metal Cu particles is smaller than the thickness of the magnetic wall by one digit, the influence on the magnetic properties is extremely small.

Next, a method of manufacturing the steel sheet according to the embodiment will be described.

Manufacturing Method

The method of manufacturing a non-oriented magnetic steel sheet according to the embodiment includes a process of heating a slab having the above-described composition, a process of obtaining the hot rolled steel sheet by performing hot rolling with respect to the slab, a process of winding the hot rolled steel sheet, a process of obtaining a cold rolled steel sheet by performing cold rolling with the hot rolled steel sheet, a process of obtaining a recrystallized steel sheet by performing first annealing with respect to the cold rolled steel sheet, and a process of precipitating the metal Cu particles in the crystal grain by performing second annealing with respect to the recrystallized steel sheet. In the hot rolling process, the finish hot rolling start temperature F0T is set to be 1000° C. or lower, and the finishing hot rolling end temperature FT is set to be 900° C. or lower. In the winding process, the winding temperature CT is set to be 500° C. or lower. In the first annealing process (recrystallization process), a soaking temperature is set to e 850° C. to 1100° C., soaking time is set to be 10 seconds or more, and an average cooling rate within a temperature range of 800° C. to 400° C. after finishing the soaking is set to be 10° C./seconds or more. In the second annealing process (Cu precipitation process), the soaking temperature is set to be 450° C. to 650° C., and the soaking time is set to be 10 seconds or more.

The above-described manufacturing method may further include a process of holding the temperature of the cold rolled steel sheet to be within a predetermined temperature range after the first annealing process instead of the second annealing process (Cu precipitation process). In a case where the manufacturing method includes the holding process, the cooling rate after the soaking is not regulated in the recrystallization annealing process, and in the holding process, the holding temperature is set to he 450° C. to 600° C., and the holding time is set to be 10 seconds or more.

The above-described manufacturing method may further include a process of performing third annealing with respect to the hot rolled steel sheet. In a case where the manufacturing method includes the third annealing process, in the third annealing process (hot rolled sheet annealing process), the soaking temperature is set to be 750° C. to 1100° C., the soaking time is set to be 10 seconds to 5 minutes, and the average cooling rate with the temperature range of 800° C. to 400° C. after the soaking is set to be 10° C./seconds or more.

In addition, the “soaking temperature” and the “holding temperature” are temperatures at which the steel sheet is isothermally retained, and the “soaking time” and the “holding time” are the length of a period of time during which the temperature of the steel sheet is the soaking temperature or the holding temperature. In addition, “average cooling rate within the temperature range of 800° C. to 400° C.” is a value acquired by the following equation.

CR=(800-400)/t

In the equation above, CR is an average cooling rate within the temperature range of 800° C. to 400° C., and t is time (seconds) required for decreasing the temperature of the steel sheet from 800° C. to 400° C.

Hereinafter, the manufacturing method of the steel sheet according to the embodiment will be described in detail.

Heating Process

In the method of manufacturing the steel sheet according to the embodiment, first, the slab having the same composition as that of the steel sheet according to the embodiment is heated. The slab heating temperature is preferably 1050° C. to 1200° C. When the slab heating temperature is lower than 1050° C., it becomes difficult to perform the hot rolling. In a case where the slab heating temperature exceeds 1200° C., sulfide or the like is dissolved, and is finely precipitated in the cooling process after the hot rolling, grain growth properties deteriorate in the recrystallization annealing after the cold rolling, and excellent iron loss properties are not obtained.

Hot Rolling Process

Next, the hot rolled steel sheet is obtained by performing the hot rolling with respect to the heated slab. In the hot rolling process, it is mandatory to control the finish hot rolling start temperature F0T and the finishing hot rolling end temperature FT. According to the technology of the related art, in the method of manufacturing the non-oriented magnetic steel sheet which has high strength and low iron loss, and which is obtained by precipitating Cu by performing the annealing after finishing the cold rolling, it is considered that the hot rolling condition does not influence the steel sheet properties. This is because, according to the common general technical knowledge, the influence of temperature history during the hot rolling on the precipitation of Cu is reduced when the steel sheet is annealed. Therefore, according to the technology of the related art, the hot rolling condition is not particularly limited in the method of manufacturing the Cu precipitation type high-strength non-oriented magnetic steel sheet, and a condition that maximizes operation efficiency of manufacturing facility is selected. However, as illustrated in the above-described experiment and the result thereof, the inventors have found that it is important to strictly control the hot rolling condition in order to obtain the magnetic steel sheet having the high fatigue strength FS. When the Cu precipitation condition is the same, as the finish hot rolling start temperature F0T, the finishing hot rolling end temperature FT, and the winding temperature CT decrease, the fatigue strength FS of the steel sheet is improved. The reason thereof is considered as follows.

As F0T, FT and CT decrease, precipitation of Cu to ferrite grain. boundary after the hot rolling and the winding is suppressed, and finally, the amount of Cu that contributes to mechanical strength, that is, the amount of Cu in a state of supersaturated solid solution, increases. In this case, it is considered that Cu is likely to become a solid solution again even after the recrystallization annealing after the cold rolling, and as a result, the metal Cu particles are likely to be more finely precipitated by the precipitation annealing after the recrystallization and annealing. Furthermore, when the Cu precipitation condition is optimal, the 9R particles which are unlikely to be cut are formed. By the 9R particles, the fatigue strength FS of the steel sheet increases.

When considering the operation efficiency of the manufacturing facility, it is not preferable to lower the temperature of the steel sheet during the hot rolling, since the rolling resistance increases and a load of a hot rolling device increases. However, in order to improve the fatigue strength FS of the steel sheet, in the manufacturing method of the steel sheet according to the embodiment, the finish hot rolling start temperature F0T is set to be 1000° C. or lower. The finish hot rolling start temperature F0T is preferably 980° C. or lower or 950° C. or lower. However, in a case where the finish hot rolling start temperature F0T is excessively low, the rolling resistance becomes excessively high. When considering the facility capacity, the finish hot rolling start temperature F0T is unlikely to be set to be lower than 900° C.

Furthermore, in the method of manufacturing the steel sheet according to the embodiment, the finishing hot rolling end temperature FT is set to be 900° C. or lower or 830° C. or lower. However, in a case where the finishing hot rolling end temperature FT becomes excessively low, the rolling resistance becomes excessively high. When considering the facility capacity, the finishing hot rolling end temperature FT is unlikely to be set to be lower than 600° C.

The finish sheet thickness of the hot rolling is preferably 2.7 mm or less. In a case where the sheet thickness exceeds 2.7 mm, there is a concern that it is necessary to increase reduction during the cold rolling, and there is a concern that high reduction deteriorates a texture. However, in a case where the finish sheet thickness of the hot rolling is excessively thin, it becomes difficult to perform the hot rolling and productivity deteriorates. Therefore, it is preferable that the finish sheet thickness of the hot rolling is 1.6 mm or more.

Winding Process

Next, the steel sheet which is hot-rolled is wound. As described above, as the winding temperature CT of the hot rolled steel sheet decreases, the amount of Cu in a supersaturated state increases, and the winding temperature CT contributes to increasing the mechanical strength of the final product. Furthermore, when CT is high, Cu is precipitated in the coil after the winding, toughness of the hot rolled steel sheet deteriorates. Therefore, the winding temperature CT is set to be 500° C. or lower. The winding temperature CT is preferably 470° C. or lower, and is more preferably 450° C. or lower. However, in a case where the winding temperature CT of the hot rolled steel sheet is excessively low, the shape of coil deteriorates, and thus, the winding temperature CT is 350° C. or higher.

Third Annealing Process (Hot Rolled Sheet Annealing Process)

In order to improve the texture of the magnetic steel sheet and to obtain the high magnetic flux density, the hot rolled sheet annealing may be performed with respect to the hot rolled steel sheet before performing the cold rolling with respect to the hot rolled steel sheet. The preferable soaking temperature in the hot rolled sheet annealing is 750° C. to 1100° C., and the preferable soaking time is .10 seconds to 5 minutes. When the soaking temperature is lower than 750° C. or the soaking time is less than 10 seconds, the effect of improving the texture is small. In a case where the soaking temperature exceeds 1100° C., or in a case where the soaking time exceeds 5 minutes, an increase in manufacturing costs is caused by an increase in energy consumption or deterioration of supplementary facility.

In addition, after the cold rolling, in order to make Cu in the steel sheet tine before the recrystallization and to make Cu solid solution again during the recrystallization annealing after the cold rolling, cold rolling is performed at an average cold rolling rate of 10° C./seconds or more within a temperature range of 800° C. to 400° C. in the hot rolling sheet annealing process. it is preferable that the average cooling rate in the hot rolling sheet annealing process is 20° C./seconds or more, or 40° C./seconds or more. A high average cooling rate in the hot rolling sheet annealing process ensures toughness of the hot rolled annealed sheet.

Cold Rolling Process

Furthermore, in the method of manufacturing the steel sheet according to the embodiment, the cold rolled steel sheet is obtained by performing the cold rolling with respect to the hot rolled steel sheet. The cold rolling may be performed one time, or may be performed two or more times including intermediate annealing, In any case, in the cold rolling, the final reduction is set to be 60% to 90% and is preferably 65% to 82%. Accordingly, in the final product, a proportion of the crystal grain of which a {111} surface is parallel to the steel sheet surface decreases, and the steel sheet having the high magnetic flux density and low iron loss is obtained.

The soaking temperature during the intermediate annealing is preferably 900° C. to 1100° C. In this case, during the cooling after the soaking, it is also desirable to set the average cooling rate to be 10° C./seconds or more within the temperature range of 800° C. to 400° C.

First Annealing Process (Recrystallization Process)

Furthermore, in the method of manufacturing the steel sheet according to the embodiment, the annealing is performed with respect to the cold rolled steel sheet, and the structure of the cold rolled steel sheet is recrystallized. In the recrystallization process, when recrystallizing the structure of the steel sheet, Cu becomes solution. In order to set the average crystal grain size of the ferrite grains to be 30 μm or more, and in order to make Cu solid solution, the soaking temperature in the recrystallization process is set to be 850° C. or higher. The soaking temperature in the recrystallization process is preferably 950° C. or higher.

Meanwhile, when the soaking temperature is excessively high, the energy consumption increases, and the supplementary facility, such as hearth roll, is likely to be damaged. Therefore, the soaking temperature is 1100° C. or lower in the recrystallization process. The soaking temperature in the recrystallization process is preferably 1050° C. or lower.

The soaking time in the recrystallization process is 10 seconds or more. In a case where the soaking time is not sufficient in the recrystallization process, the ferrite grain does not grow, and thus, the iron loss is not sufficiently reduced. In addition, the inventors have confirmed that the 9R particle ratio is also insufficient in this case. Meanwhile, in a case where the soaking time is excessively long, the productivity deteriorates, and thus, the soaking time is preferably 2 minutes or less in the recrystallization process. Furthermore, in the cooling after the soaking in the recrystallization process, the average cooling rate is set to be 10° C./seconds or more within the temperature range from 800° C. to 400° C. This is for preventing solid solution Cu from being precipitated in the cooling process after the soaking in the recrystallization process. The average cooling rate within the temperature range of 800° C. to 400° C. after the soaking in the recrystallization process is preferably 20° C./seconds or more. In a case where the average cooling rate within the temperature range from 800° C. to 400° C. after the soaking in the recrystallization process is not sufficient, metal Cu particles are precipitated and are coarsened in the following process, and the number density of the metal Cu particles is not sufficient.

Second Annealing Process (Cu Precipitation Process)

In the method of manufacturing the steel sheet according to the embodiment, the recrystallized steel sheet obtained by the recrystallization process is further annealed, and the metal Cu particles are precipitated in the crystal grain. In order to suppress the average grain size, the number density, and the crystal structure of the metal Cu particles precipitated in the ferrite grain to be within the above-described range, it is necessary to set the soaking temperature to be 450° C. to 650° C. in the Cu precipitation process, and to set the soaking time to be 10 seconds or more.

In a case where the soaking temperature of the Cu precipitation process is lower than 450° C., the metal Cu particles are excessively fine, and the 9R particles are not precipitated. In this case, all of the metal Cu particles are substantially the BCC particles which do not function as resistance with respect to the movement of dislocation. in a case where the soaking temperature of the Cu precipitation process exceeds 650° C., the metal Cu particles are coarsened, and the number density of the metal Cu particles is insufficient. The soaking temperature of the Cu precipitation process is preferably 500° C. to 625° C., and is more preferably 525° C. to 600° C.

In addition, as illustrated in FIGS. 2 and 3, the soaking temperature of the Cu precipitation process in which the tensile strength of the steel sheet is the maximum, and the soaking temperature of the Cu precipitation process in which the fatigue strength of the steel sheet is the maximum, does not necessarily match each other. In addition, the soaking temperature of the Cu precipitation process in which the tensile strength or the fatigue strength of the steel sheet is the maximum, changes in accordance with the hot rolling condition and the winding condition of the steel sheet. In particular, it is considered that the soaking temperature of the Cu precipitation process in which the fatigue strength of the steel sheet is the maximum increases as the finish hot rolling start temperature, the finish temperature, and the winding temperature decrease. In accordance with the type of the strength required by the steel sheet, and in accordance with the hot rolling condition and the winding condition of the steel sheet, it is preferable to appropriately select the soaking temperature of the Cu precipitation process.

In addition, in order to suppress the average grain size, the number density, and the crystal structure of the metal Cu particles precipitated in the ferrite grain to be within the above-described range, it is necessary to set the soaking time of the Cu precipitation process to be 10 seconds or more. The soaking time of the Cu precipitation process is preferably 30 seconds or more, and is more preferably 40 seconds or more. According to the above-described temperature range, it is also possible to perform the second annealing for several hours of soaking time in batch annealing. The optimal condition of the soaking temperature and the soaking time of the Cu precipitation process slightly changes by the composition of the steel sheet, and particularly, the amount of Cu, but is generally included in the above-described range.

In the method of manufacturing the steel sheet according to the embodiment, it is possible to simultaneously perform the recrystallization annealing and the Cu precipitation annealing by one continuous annealing line. In this case, the soaking temperature is 850° C. to 1050° C., the soaking time is 10 seconds or more, and the time period during which the steel sheet is held within the temperature range of 600° C. to 450° C. of the cooling process is 10 seconds or more.

In the steel sheet obtained by the method of manufacturing the steel sheet according to the embodiment, as necessary, it is possible to perform an insulating film, to obtain the non-oriented magnetic steel sheet having a high strength and low iron loss.

### EXAMPLES

Next, Examples of the present invention will be described, but the condition in Example is one example of condition employed for ensuring the possibility of realization and effects of the present invention, and the present invention is not limited to the one example of condition. The present invention can be obtained by employing various conditions as long as the object of the present invention is achieved without departing the main ideas of the present invention.

In an evaluation method of the example of the invention and the comparative example in all of the experiments is as follows. In addition, in some comparative examples, cracks or surface defects are generated in the middle of the manufacturing, the manufacturing process is stopped at this point, and thus, the evaluation is not performed.

The area ratio of the ferrite grains which do not contain the unrecrystallized structure was measured by a general method of observing a metallographic structure. In other words, after polishing the section of the steel sheet, when etching the polished surface by the etchant, such as nital solution, the ferrite grains which were recrystallized were observed as bright plain crystal grains. Meanwhile, an irregular dark pattern on the inside of the unrecrystallized ferrite grains was observed. Therefore, based on the structure photo obtained by the general method of observing a metallographic structure, the area proportion of the recrystallized ferrite grains which took the entire structure (area ratio of ferrite grains which do not contain the unrecrystallized structure), was acquired.

The average crystal grain size of the ferrite grains, which did not contain the unrecrystallized structure, was acquired according to ITS G 0551 “Microscope Test Method of Steel-Grain Size”.

The number density and the average grain size of the metal Cu particles in the ferrite grains were acquired by the method of photographing a transmission type electrode microscope photo which was described in advance. In addition, the metal Cu particles of which the particle size was less than 2.0 nm were out of the measurement target.

The 9R particle ratio and the BCC particle ratio were acquired by specifying the structure of the particles contained in a bright field image and an electron beam diffraction image when observing using the transmission electron microscope, and by measuring the number proportion of the particles. In addition, the metal Cu particles of which the particle size is less than 2.0 nm are out of the measurement target.

The measurement of the yield stress YS and the tensile strength TS was performed according to JIS Z 2241 “Method of Tension Test of Metal Material”. The test piece was a JIS No. 5 test piece or JIS No. 13 B test piece. An example in which YS was 450 MPa or more was an example in which the yield stress was excellent, and an example in which TS was 550 MPa or more was an example in which the tensile strength was excellent.

The measurement method of FS was performed according to the JIS Z 2273 “General Rule of Method of Fatigue Test of Metal Material”. The fatigue test piece illustrated in FIGS. 1-1 and 1-2 was cut out from the steel sheet for evaluation, and the fatigue test was performed by partially pulsating tension. The longitudinal direction of the fatigue test piece matches the rolling direction of the steel sheet for evaluation. In the fatigue test, the minimum load was set to be constant to be 3 kgf, the frequency was set to be 20 Hz, the maximum stress in a case where the number of times of repeating stress was 2000000 and breaking did not occur was set to be the fatigue strength FS of the steel sheet for evaluation. An example in which FS was 300 MPa or more was considered as an example in which the fatigue strength was excellent.

The measurement of W_{10/400} and B₅₀ was performed according to HS C 2556 “Test Method of Single Sheet Magnetic Properties of Magnetic Steel Sheet”. An example in which W_{10/400} was 22 W/kg or less was considered as an example in which the iron loss was excellent. An example in which B₅₀ was 1.55 T or more was considered as an example in which magnetic flux density was excellent.

### Example 1

A cast piece was manufactured by vacuum-dissolving and casting the steel having the composition illustrated in Table 4-1, the cast piece was heated to 1150° C., the case piece was used in the hot rolling at the finish hot rolling start temperature of 930° C., the hot rolling was finished at a finish temperature of 850° C., and the hot rolled steel sheet having a finish thickness of 2.3 mm was wound at a winding temperature of 400° C.

After this, with respect to the above-described hot rolled steel sheet, after performing the hot rolled sheet annealing at the soaking temperature of 1000° C. and for the soaking time of 30 seconds, the hot rolled steel sheet was used in the cold rolling, and a cold rolled steel sheet having 0.35 mm was obtained.

With respect to the cold rolled steel sheet, by performing the recrystallization annealing at the soaking temperature of 1000° C. for the soaking time of 30 seconds at an average cooling rate of 20° C./seconds at 800° C. to 400° C., and then, by performing the Cu precipitation annealing at the soaking temperature of 550° C. for the soaking time of 60 seconds, the non-oriented magnetic steel sheet was obtained.

The average crystal grain size of the ferrite grains (average crystal grain size), the average grain size of the metal Cu particles in the ferrite grains, the number density, the crystal structure, the 9R particle ratio, and the BCC particle ratio in the obtained magnetic steel sheet, were illustrated in Table 4-2, and the mechanical properties (the yield stress YS, the tensile strength TS, and the fatigue strength FS) and the magnetic properties (the iron loss W_{10/400} and the magnetic flux density B₅₀) were illustrated in Table 4-3. in addition, the area ratio of ferrite, which did not contain the unrecrystallized structure in the metallographic structure in all of the examples, was 99.0% by area or more.

TABLE 4-1

| | STEEL | CHEMICAL COMPOSITION (MASS %) | | | | | | | |
|---|---|---|---|---|---|---|---|---|---|
| | No. | C | Si | Mn | Al | Cu | Ni | Ca | REM |
| EXAMPLE | A1 | 0.0034 | 2.99 | 0.22 | 0.65 | 1.20 | — | — | — |
| OF | A2 | 0.0013 | 2.20 | 0.24 | 0.33 | 1.30 | — | — | — |
| INVENTION | A3 | 0.0020 | 3.40 | 0.19 | 0.29 | 1.50 | — | — | — |
| | A4 | 0.0018 | 2.65 | 0.08 | 0.95 | 1.24 | — | — | — |
| | A5 | 0.0022 | 2.95 | 0.40 | 0.32 | 1.52 | — | — | — |
| | A6 | 0.0020 | 2.86 | 0.21 | 0.30 | 1.18 | — | — | — |
| | A7 | 0.0018 | 1.10 | 0.22 | 2.70 | 1.22 | — | — | — |
| | A8 | 0.0017 | 2.92 | 0.21 | 0.71 | 0.81 | — | — | — |
| | A9 | 0.0014 | 2.96 | 0.22 | 0.68 | 1.80 | — | — | — |
| | A10 | 0.0014 | 2.96 | 0.19 | 0.69 | 1.16 | — | — | — |
| | A11 | 0.0015 | 2.96 | 0.20 | 0.68 | 1.20 | 1.20 | — | — |
| | A12 | 0.0014 | 2.96 | 0.20 | 0.70 | 1.20 | 1.20 | — | 0.0070 |
| | A13 | 0.0015 | 2.96 | 0.20 | 0.69 | 1.21 | — | — | 0.0065 |
| | A14 | 0.0014 | 2.96 | 0.19 | 0.69 | 1.21 | — | 0.0010 | 0.0040 |
| COMPARATIVE | B1 | 0.0150 | 2.96 | 0.24 | 0.66 | 1.22 | — | — | — |
| EXAMPLE | B2 | 0.0030 | 0.50 | 0.25 | 0.34 | 1.23 | — | — | — |
| | B3 | 0.0024 | 4.60 | 0.25 | 0.33 | 1.22 | — | — | — |
| | B4 | 0.0025 | 2.90 | 0.03 | 0.32 | 1.18 | — | — | — |
| | B5 | 0.0031 | 3.30 | 1.40 | 1.20 | 1.16 | — | — | — |
| | B6 | 0.0085 | 2.89 | 0.24 | 0.03 | 1.15 | — | — | — |
| | B7 | 0.0020 | 2.90 | 0.23 | 3.50 | 1.15 | — | — | — |
| | B8 | 0.0023 | 2.93 | 0.32 | 0.35 | 0.20 | — | — | — |
| | B9 | 0.0024 | 2.95 | 0.28 | 0.33 | 2.40 | — | — | — |

TABLE 4-2

| | | AVERAGE | METAL Cu PARTICLES IN FERRITE GRAIN | | | | |
|---|---|---|---|---|---|---|---|
| | | CRYSTAL | AVERAGE | NUMBER | | 9R | BCC |
| | STEEL | GRAIN SIZE | GRAIN SIZE | DENSITY | CRYSTAL | PARTICLE | PARTICLE |
| | No. | [μm] | [nm] | [NUMBER/μm³] | STRUCTURE | RATIO | RATIO |
| EXAMPLE | A1 | 73 | 2.2 | 1840000 | BCC + 9R | 5% | 95% |
| OF | A2 | 103 | 2.9 | 873000 | BCC + 9R | 10% | 90% |
| INVENTION | A3 | 75 | 2.5 | 1570000 | BCC + 9R | 7% | 93% |
| | A4 | 74 | 2.6 | 1120000 | BCC + 9R | 7% | 93% |
| | A5 | 82 | 2.8 | 1110000 | BCC + 9R | 11% | 89% |
| | A6 | 83 | 2.3 | 1610000 | BCC + 9R | 4% | 96% |
| | A7 | 79 | 2.5 | 1250000 | BCC + 9R | 10% | 90% |
| | A8 | 93 | 2.1 | 1410000 | BCC + 9R | 2% | 98% |
| | A9 | 72 | 3.6 | 1200000 | BCC + 9R | 32% | 68% |
| | A10 | 88 | 2.4 | 1420000 | BCC + 9R | 8% | 92% |
| | A11 | 85 | 2.8 | 895000 | BCC + 9R | 15% | 85% |
| | A12 | 110 | 2.7 | 1030000 | BCC + 9R | 15% | 85% |
| | A13 | 120 | 2.8 | 850000 | BCC + 9R | 15% | 85% |
| | A14 | 125 | 2.7 | 998000 | BCC + 9R | 18% | 82% |
| COMPARATIVE | B1 | 63 | 4.1 | 599000 | BCC + 9R | 22% | 78% |
| EXAMPLE | B2 | 52 | COULD NOT BE OBSERVED | | | | |
| | B3 | CRACKS WERE GENERATED IN COLD ROLLING | | | | | |
| | B4 | 62 | 2.5 | 1250000 | BCC + 9R | 7% | 93% |
| | B5 | CRACKS WERE GENERATED IN COLD ROLLING | | | | | |
| | B6 | 24 | 2.5 | 1040000 | BCC + 9R | 9% | 91% |

| B7 | CRACKS WERE GENERATED IN COLD ROLLING | |
|---|---|---|
| B8 | 89 | COULD NOT BE OBSERVED |

| | |
|---|---|
| B9 | SURFACE DEFECTS WERE GENERATED IN HOT ROLLING |

TABLE 4-3

| | | PROPERTIES | | | | |
|---|---|---|---|---|---|---|
| | STEEL | YS | TS | FS | W_{10/400} | B₅₀ |
| | No. | [MPa] | [MPa] | [MPa] | [W/kg] | [T] |
| EXAMPLE | A1 | 620 | 740 | 530 | 18.9 | 1.56 |
| OF | A2 | 520 | 550 | 390 | 21.2 | 1.68 |
| INVENTION | A3 | 670 | 770 | 540 | 16.8 | 1.62 |
| | A4 | 620 | 690 | 490 | 18.3 | 1.63 |
| | A5 | 640 | 730 | 500 | 17.2 | 1.64 |
| | A6 | 575 | 610 | 480 | 18.9 | 1.65 |
| | A7 | 610 | 710 | 490 | 19.4 | 1.60 |
| | A8 | 580 | 620 | 420 | 17.2 | 1.65 |
| | A9 | 690 | 810 | 605 | 18.6 | 1.62 |
| | A10 | 600 | 720 | 510 | 17.4 | 1.64 |
| | A11 | 610 | 690 | 520 | 16.2 | 1.63 |
| | A12 | 590 | 630 | 450 | 17.0 | 1.65 |
| | A13 | 580 | 620 | 450 | 16.5 | 1.63 |
| | A14 | 570 | 590 | 430 | 19.3 | 1.66 |
| COMPARATIVE | B1 | 610 | 720 | 510 | 24.3 | 1.62 |
| EXAMPLE | B2 | 290 | 410 | 200 | 23.2 | 1.71 |
| | B3 | CRACKS WERE GENERATED IN COLD ROLLING | | | | |
| | B4 | 600 | 700 | 480 | 22.2 | 1.61 |
| | B5 | CRACKS WERE GENERATED IN COLD ROLLING | | | | |
| | B6 | 610 | 700 | 490 | 23.5 | 1.60 |
| | B7 | CRACKS WERE GENERATED IN COLD ROLLING | | | | |
| | B8 | 440 | 535 | 295 | 18.2 | 1.65 |

| | |
|---|---|
| B9 | SURFACE DEFECTS WERE GENERATED IN HOT ROLLING |

Examples of the invention A1 to A14 in which the chemical compositions were within a regulation range of the present invention, had both of the excellent mechanical properties and the excellent iron loss.

Meanwhile, in Comparative Example B1 in which the amount of C was excessive, the iron loss was not sufficiently reduced.

In Comparative Example B2 in which the amount of Si was not sufficient, the mechanical strength was damaged since the precipitation strength was not generated, and further, the iron loss increases.

In Comparative Example B3 in which the amount of Si was excessive, the rolling properties deteriorate by the embrittlement, and the cracks were generated during the cold rolling.

In Comparative Example B4 in which the amount of Mn was not sufficient, the iron loss was not sufficiently reduced.

In Comparative example B5 in which the amount of Mn was excessive, the rolling properties deteriorate by the embrittlement, and the cracks were generated during the cold rolling.

In Comparative Example B6 in which the amount of Al was not sufficient, the iron loss was not sufficiently reduced.

In Comparative example B7 in which the amount of Al was excessive, the rolling properties deteriorate by the embrittlement, and the cracks were generated during the cold rolling.

In Comparative example B8 in which the amount of Cu was not sufficient, the metal Cu particles were not sufficiently precipitated in the ferrite grain, the precipitation strength was not generated, and thus, the mechanical properties were not sufficient.

In Comparative example B9 in which the amount of Cu was excessive, the defects were generated in the surface of the steel sheet during the hot rolling.

### Example 2

By employing the manufacturing method under the condition illustrated in Table 5-1 with respect to the steel having the chemical composition of steel No. A10 illustrated in Table 4-1, the examples of the invention and the comparative examples of the non-oriented magnetic steel sheet were obtained. The average crystal grain size of the ferrite grain, the average grain size of the metal Cu particles, the number density, the crystal structure, the 9R particle ratio, and the BCC particle ratio in the examples of the invention and the comparative examples were illustrated in Table 5-2. The mechanical properties and the magnetic properties of the examples of the invention and the comparative examples were illustrated in Table 5-3. In addition, the area ratio of ferrite, which did not contain the unrecrystallized structure in the metallographic structure in all of the magnetic steel sheets, was 99.0% by area or more.

TABLE 5-1

| | | HOT ROLLING | | | | | | |
|---|---|---|---|---|---|---|---|---|
| | | | FINISH | | | | | |
| | | | HOT | | | | | |
| | | | ROLLING | FINISH | | WINDING | HOT ROLLING | |
| | | SLAB | START | TEM- | FIN- | WINDING | SHEET ANNEALING | |
| | REFER- | HEATING | TEMPERA- | PERA- | ISH | TEMPERA- | SOAKING | |
| | ENCE | TEMPERA- | TURE | TURE | THICK- | TURE | TEMPERA- | SOAKING |
| | NUM- | TURE | FOT | FT | NESS | CT | TURE | TIME |
| | BER | [° C.] | [° C.] | [° C.] | [mm] | [° C.] | [° C.] | [sec] |
| EX- | C1 | 1130 | 990 | 890 | 2.3 | 490 | | |
| AM- | C2 | 1090 | 910 | 820 | 2.3 | 410 | | |
| PLE | C3 | 1090 | 930 | 820 | 2.3 | 410 | | |
| | C4 | 1090 | 920 | 820 | 2.3 | 410 | | |
| | C5 | 1090 | 920 | 820 | 2.3 | 410 | | |
| | C6 | 1090 | 930 | 820 | 2.3 | 410 | | |
| | C7 | 1090 | 920 | 820 | 2.3 | 410 | | |
| | C9 | 1090 | 920 | 820 | 2.3 | 410 | | |
| | C10 | 1090 | 920 | 820 | 2.3 | 410 | | |
| | C11 | 1120 | 910 | 850 | 2.3 | 450 | 1050 | 15 |
| | C12 | 1120 | 960 | 850 | 2.3 | 450 | 820 | 60 |
| | C13 | 1120 | 930 | 850 | 2.3 | 450 | 1000 | 120 |
| | C14 | 1120 | 910 | 850 | 2.3 | 450 | 1000 | 45 |
| COM- | D1 | 1160 | 1030 | 950 | 2.3 | 700 | | |
| PAR- | D2 | 1120 | 1020 | 850 | 2.3 | 450 | | |
| A- | D3 | 1050 | 1010 | 850 | 2.3 | 450 | | |
| TIVE | D4 | 1120 | 990 | 850 | 3.3 | 450 | | |
| EX- | D5 | 1120 | 1000 | 850 | 4.3 | 450 | | |
| AM- | D6 | 1120 | 980 | 850 | 2.3 | 450 | | |
| PLE | D7 | 1120 | 990 | 850 | 2.3 | 450 | | |
| | D8 | 1120 | 1000 | 850 | 2.3 | 450 | | |
| | D9 | 1120 | 1000 | 850 | 2.3 | 450 | | |
| | | HOT | | | | | | |
| | | ROLLING | | | | | | |

| | |
|---|---|
| SHEET | RECRYSTALLIZATION |

| | | ANNEALING | ANNEALING | | | | | |
|---|---|---|---|---|---|---|---|---|
| | | COOLING | | | COOLING | HOLDING | | |
| | | RATE | | | RATE | HOLDING | Cu | |
| | | AT | | | AT | TIME | PRECIPITATING | |
| | | 800° | | | 800° | AT | ANNEALING | |
| | | C. | SOAK- | | C. | 600° | SOAK- | |
| | | TO | ING | | TO | C. | ING | |
| | REFER- | 400° | TEM | SOAK- | 400° | TO | TEM | SOAK- |
| | ENCE | C. | PERA- | ING | C. | 450° | PERA- | ING |
| | NUM- | [° C./ | TURE | TIME | [° C./ | C. | TURE | TIME |
| | BER | sec] | [° C.] | [sec] | sec] | [sec] | [° C.] | [sec] |
| EX- | C1 | | 1000 | 30 | 40 | | 550 | 30 |
| AM- | C2 | | 1080 | 10 | 50 | | 550 | 30 |
| PLE | C3 | | 870 | 60 | 40 | | 550 | 30 |
| | C4 | | 1000 | 30 | 12 | | 550 | 30 |
| | C5 | | 1000 | 30 | 40 | | 550 | 30 |
| | C6 | | 1000 | 30 | 40 | | 550 | 60 |
| | C7 | | 1000 | 30 | 40 | | 630 | 10 |
| | C9 | | 1000 | 30 | — | 20 | | |
| | C10 | | 1000 | 30 | — | 10 | | |
| | C11 | 45 | 1000 | 30 | 26 | | 550 | 30 |
| | C12 | 40 | 1000 | 30 | 26 | | 550 | 30 |
| | C13 | 15 | 1000 | 30 | 26 | | 550 | 30 |
| | C14 | 40 | 1000 | 30 | 26 | | 550 | 30 |
| COM- | D1 | | 1000 | 30 | 40 | | 550 | 30 |
| PAR- | D2 | | 800 | 30 | 20 | | 550 | 30 |
| A- | D3 | | 1120 | 90 | 20 | | 550 | 30 |
| TIVE | D4 | | 870 | 5 | 20 | | 550 | 30 |
| EX- | D5 | | 1000 | 30 | 4 | | 550 | 30 |
| AM- | D6 | | 1000 | 30 | 20 | | 550 | 1 |
| PLE | D7 | | 1000 | 30 | 40 | | 400 | 30 |
| | D8 | | 1000 | 30 | 40 | | 720 | 30 |
| | D9 | | 1000 | 30 | — | 5 | | |

TABLE 5-2

| | | AVERAGE | METAL Cu PARTICLES IN FERRITE GRAIN | | | | |
|---|---|---|---|---|---|---|---|
| | | CRYSTAL | AVERAGE | | | | |
| | | GRAIN | GRAIN | NUMBER | | 9R | BCC |
| | REFERENCE | SIZE | SIZE | DENSITY | CRYSTAL | PARTICLE | PARTICLE |
| | NUMBER | [μm] | [nm] | [NUMBER/μm³] | STRUCTURE | RATIO | RATIO |
| EXAMPLE | C1 | 90 | 2.3 | 4840000 | BCC + 9R | 2% | 98% |
| | C2 | 163 | 2.5 | 3770000 | BCC + 9R | 4% | 96% |
| | C3 | 32 | 2.7 | 2990000 | BCC + 9R | 4% | 96% |
| | C4 | 81 | 2.4 | 4260000 | BCC + 9R | 5% | 95% |
| | C5 | 82 | 2.6 | 3350000 | BCC + 9R | 8% | 92% |
| | C6 | 80 | 4.5 | 646923 | BCC + 9R | 29% | 71% |
| | C7 | 84 | 7.8 | 124000 | BCC + 9R | 62% | 38% |
| | C9 | 80 | 2.5 | 3770000 | BCC + 9R | 3% | 97% |
| | C10 | 78 | 2.1 | 6360000 | BCC + 9R | 2% | 98% |
| | C11 | 82 | 2.3 | 4840000 | BCC + 9R | 4% | 96% |
| | C12 | 85 | 2.7 | 2990000 | BCC + 9R | 5% | 95% |
| | C13 | 80 | 2.5 | 3770000 | BCC + 9R | 4% | 96% |
| | C14 | 88 | 2.4 | 4260000 | BCC + 9R | 5% | 95% |
| COMPARATIVE | D1 | 83 | 2.4 | 684000 | BCC | 0% | 100% |
| EXAMPLE | D2 | 15 | 2.2 | 1700000 | BCC + 9R | 2% | 98% |
| | D3 | 240 | 2.8 | 895000 | BCC + 9R | 4% | 96% |
| | D4 | 18 | 2.2 | 1900000 | BCC + 9R | 1% | 99% |
| | D5 | 77 | 18.0 | 3370 | 9R + FCC | 5% | 0% |
| | D6 | 79 | COULD NOT BE OBSERVED | | | | |
| | D7 | 78 | COULD NOT BE OBSERVED | | | | |
| | D8 | 80 | 28.0 | 905 | 9R + FCC | 1% | 0% |

| | | |
|---|---|---|
| D9 | 82 | COULD NOT BE OBSERVED |

TABLE 5-3

| | | PROPERTIES OF PRODUCT | | | | |
|---|---|---|---|---|---|---|
| | REFERENCE | YS | TS | FS | W_{10/400} | B₅₀ |
| | NUMBER | [MPa] | [MPa] | [MPa] | [W/kg] | [T] |
| EXAMPLE | C1 | 590 | 700 | 500 | 17.3 | 1.59 |
| | C2 | 540 | 680 | 450 | 18.2 | 1.57 |
| | C3 | 640 | 750 | 550 | 19.0 | 1.61 |
| | C4 | 580 | 680 | 470 | 18.0 | 1.59 |
| | C5 | 610 | 740 | 510 | 17.6 | 1.59 |
| | C6 | 620 | 750 | 520 | 17.6 | 1.59 |
| | C7 | 580 | 690 | 460 | 17.5 | 1.59 |
| | C9 | 580 | 690 | 470 | 17.5 | 1.59 |
| | C10 | 590 | 700 | 480 | 17.7 | 1.59 |
| | C11 | 615 | 720 | 500 | 17.6 | 1.65 |
| | C12 | 600 | 720 | 500 | 17.5 | 1.61 |
| | C13 | 600 | 710 | 510 | 17.8 | 1.64 |
| | C14 | 600 | 720 | 510 | 17.4 | 1.64 |
| COMPARATIVE | D1 | 400 | 520 | 290 | 17.6 | 1.58 |
| EXAMPLE | D2 | 590 | 690 | 480 | 23.1 | 1.61 |
| | D3 | 420 | 480 | 290 | 21.0 | 1.51 |
| | D4 | 590 | 690 | 470 | 25.0 | 1.58 |
| | D5 | 440 | 490 | 280 | 21.5 | 1.59 |
| | D6 | 390 | 490 | 330 | 17.5 | 1.59 |
| | D7 | 380 | 490 | 320 | 17.9 | 1.58 |
| | D8 | 460 | 510 | 340 | 23.4 | 1.59 |
| | D9 | 380 | 450 | 310 | 17.5 | 1.59 |

Examples of the invention C1 to C14 in which the manufacturing condition is within the regulation range of the present invention, had both of the excellent mechanical properties and the excellent iron loss.

Meanwhile, in Comparative Example D1 in which the finish hot rolling start temperature F0T, the finishing hot rolling end temperature FT, and the winding temperature CT were excessively high, the 9R particle ratio was not sufficient, and thus, the fatigue strength was not sufficient.

In Comparative Example D2 in which the finish hot rolling start temperature F0T, was excessively high and the soaking temperature in the recrystallization annealing was not sufficient, the ferrite grains were excessively fine, and thus, the iron loss was not sufficiently reduced.

In Comparative Example D3 in which the finish hot rolling start temperature F0T and the soaking temperature in the recrystallized annealing are excessively high, the average grain size of the ferrite grains was coarsened, and thus, the mechanical strength was damaged, and further, the magnetic properties were also not excellent.

In Comparative Example D4 in which the temperature in the recrystallization annealing was low and the soaking time was also not sufficient, the ferrite grains are excessively fine, and thus, the iron loss wa.s not sufficiently reduced.

In Comparative Example D5 in which the cooling rate after the soaking in the recrystallization annealing was not sufficient, the metal Cu particles are coarsened, the number density of the metal Cu particles was not sufficient, and thus, the mechanical strength was damaged. In addition, since the coarse Cu particles prevent the movement of the magnetic wall, in Comparative Example D5, the iron loss was also not sufficiently reduced.

In Comparative Example D6 in which the soaking time was not sufficient in the Cu precipitation annealing, the metal Cu particles having an effect of precipitation strengthening were not precipitated, and thus, the mechanical strength was damaged.

In Comparative Example D7 in which the soaking temperature was excessively low in the Cu precipitation annealing, the metal Cu particles having an effect of precipitation strengthening were not precipitated, and thus, the mechanical strengh was damaged.

In Comparative Example D8 in which the soaking temperature was excessively high in the Cu precipitation annealing, the metal Cu particles were coarsened, the number density of the metal Cu particles was not sufficient, and thus, the mechanical strength was damaged. In addition, the coarsened Cu deteriorates the hysteresis loss, and thus, in Comparative Example D8, the iron loss was also not sufficiently reduced.

In Comparative Example D9 in which the holding time wa.s not sufficient in the holding process, similar to Comparative Example D6 in which the soaking time was not sufficient in the Cu precipitation annealing, the metal Cu particles having an effect of precipitation strengthening were not precipitated, and thus, the mechanical strength was damaged.

### INDUSTRIAL APPLICABILITY

As described above, according to the present invention, it is possible to manufacture and provide a non-oriented magnetic steel sheet having low iron loss and excellent fatigue properties. Since the non-oriented magnetic steel sheet of the present invention can contribute to increasing the rotational speed of a motor and increasing efficiency of the motor, the present invention has a high use industrial applicability.

1. A non-oriented magnetic steel sheet comprising, as a composition, by mass %:
C: 0% to 0.0100%;
Si: 1.00% to 4.00%;
Mn: 0.05% to 1.00%;
Al: 0.10% to 3.00%;
Cu: 0.50% to 2.00%;
Ni: 0% to 3.00%;
Ca: 0% to 0.0100%:
REM: 0% to 0.0100%;
Sn: 0% to 0.3%;
Sb: 0% to 0.3%;
S: 0% to 0.01%;
P: 0% to 0.01%;
N: 0% to 0.01%;
O: 0% to 0.01%;
Ti: 0% to 0.01%;
Nb: 0% to 0.01%;
V: 0% to 0.01%;
Zr: 0% to 0.01%;
Mg: 0% to 0.01%; and
a remainder of Fe and impurities,
wherein a structure contains 99.0% by area or more of ferrite grains which do not have an unrecrystallized structure,
wherein an average crystal grain size of the :ferrite grains is 30 μm to 180 μm,
wherein the ferrite grains contain metal Cu particles of which a number density is 10,000 to 10,000,000 number/μm³ on the inside thereof, wherein the metal Cu particles on the inside of the ferrite grains contain
precipitation particles having a 9R structure of which a number density is 2% to 100% with respect to the number density of the metal Cu particles, and precipitation particles having a bec structure of which a number density is 0% to 98% with respect to the number density of the metal Cu particles, and
wherein an average grain size of the metal Cu particles on the inside of the ferrite grains is 2.0 nm to 10.0 nm.

2. The non-oriented magnetic steel sheet according to claim 1, comprising, as a composition, by mass %:
one or more selected from a group made of
Ni: 0.50% to 3.00%;
Ca: 0.0005% to 0.0100%; and
REM: 0.0005% to 0.0100%.
